(19) United States
(12) Patent Application Publication
(10) Pub. No.: US 2004/0169171 A1
(43) Pub. Date: Sep. 2, 2004

(54) Electric fence energiser

(76) Inventors: Jack Hartsone Reeves, Hamilton (NZ); Richard Lloyd Johnston, Hamilton (NZ)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/275,130

(22) PCT Filed: May 1, 2001
(86) PCT No.: PCT/NZ01/00067

(30) Foreign Application Priority Data
May 1, 2000 (NZ) 504260

(51) Int. Cl. H05C 1/00

(52) U.S. Cl. 256/10

(57) ABSTRACT

An electric fence energiser is intended to reduce exposure of an animal tangled in the fence line to high power deterrent pulses for an indefinite period. The energiser is arranged to along the fence line, sense a characteristic associated with said evaluation pulse(s) that varies with load on the fence line, and set a threshold value based on said sensed characteristic, send one or more further low power evaluation pulses along the fence line, sense a characteristic associated with the evaluation pulse(s) that varies with load on the fence line, compare the sensed characteristic to the threshold value, and when a change in the sensed characteristic relative to the threshold value indicative of an animal in contact with the fence line is detected, send one or more but not more than a predetermined maximum number of higher power deterrent pulses along the fence line, subsequently send one or more further low power evaluation pulses along the fence line, sense a characteristic associated with the evaluation pulses that varies with load on the fence line, and either re-evaluate and optionally reset the threshold, or set a new threshold value, and continue to send further low power evaluation pulses along the fence line and sense a characteristic associated with the low power evaluation pulse(s) that varies with load on the fence line, and compare the sensed characteristic to the current threshold value, and send one or more further but not more than a predetermined maximum number of higher power deterrent pulses along the fence line if a change relative to the threshold value is again detected.

### FIELD OF INVENTION

The present invention comprises an electric fence energiser and a method of operating an electric fence energiser. In particular the energiser is arranged to operate so that an animal which comes into prolonged contact with the fence line, through becoming tangled in the fence line for example, is unlikely to be exposed to higher power deterrent pulses from the energiser for an indefinite period.

### BACKGROUND OF INVENTION

Many currently available electric fence energisers are arranged to change the voltage of the output pulses of the energiser in response to changes in the fence line load across the output terminals of the energiser. An animal in contact with the fence line increases the fence line load seen by the energiser and a variable output energiser will increase or maintain its output pulse voltage or will at least attempt to do so, so that the animal will continue to receive higher power deterrent shocks, typically every second, for as long as it remains in contact with the fence line. This can be disadvantageous where an animal becomes tangled in the electric fence line however. The animal may eventually die of exhaustion from muscle spasms following each shock.

### SUMMARY OF INVENTION

It is an object of the present invention to provide an electric fence energiser and a method of operating an electric fence energiser which is arranged to operate so that an animal which comes into prolonged contact with the fence line, through becoming tangled in the fence line for example, is unlikely to be exposed to high power deterrent pulses from the energiser for an indefinite period.

In broad terms the invention comprises an electric fence energiser arranged to operate to, and a method of operating an electric fence energiser including causing the energiser to:

send one or more low power evaluation pulse(s) along a fence line, sense a characteristic associated with said evaluation pulse(s) that varies with load on the fence line, and set a threshold value based on said sensed characteristic,

send one or more further low power evaluation pulses along the fence line, sense a characteristic associated with the evaluation pulse(s) that varies with load on the fence line, compare the sensed characteristic to the threshold value, and when a change in the sensed characteristic relative to the threshold value indicative of an animal in contact with the fence line is detected, send one or more but not more than a predetermined maximum number of higher power deterrent pulses along the fence line,

subsequently send one or more further low power evaluation pulses along the fence line, sense a characteristic associated with the evaluation pulses that varies with load on the fence line, and either re-evaluate and optionally reset the threshold, or set a new threshold value, and

continue to send further low power evaluation pulses along the fence line and sense a characteristic associated with the low power evaluation pulse(s) that varies with load on the fence line and compare the sensed characteristic to the current threshold value, and send one or more but not more than a predetermined maximum number of further higher power deterrent pulses along the fence line if a change relative to the threshold value is again detected.

The sensed characteristic associated with the low power evaluation pulse(s) may be pulse voltage for example. Alternatively however any one or more of the pulse voltage, pulse current, or pulse width of the low power evaluation pulse(s), the rate of discharge of a storage capacitor or capacitors of the energiser during the low power evaluation pulse(s), or the degree of overshoot of the voltage or current wave form of a storage capacitor or capacitors of the energiser during the low power evaluation pulse(s) may be sensed.

The energiser may be arranged to send a single higher power deterrent pulse when a change in the sensed characteristic of at least one low power evaluation pulse relative to the threshold is detected, indicative of an animal in contact with the fence line, or to send a group of two or more pulses (up to a predetermined maximum number of pulses). Where the energiser is arranged to send a group of higher power deterrent pulses it may also be arranged to send a low power evaluation pulse after each higher power deterrent pulse, or after a subgroup or subgroups of higher power deterrent pulses, and to terminate sending of the remainder of the group of higher power deterrent pulses if the sensed characteristic changes indicative of animal breaking contact with the fence line. Alternatively where the energiser is arranged to send a group of higher power deterrent pulses, it may be arranged to sense a characteristic of the higher-power pulses that varies with load on the fence line and terminate sending of the remainder of the group of higher power pulses if the sensed characteristic varies indicative of an animal breaking contact with the fence line.

Preferably the low power evaluation pulses contain less than about 50% of the power of the higher power deterrent pulses. The low power evaluation pulses may for example contain less than about 10% of the power of the higher power pulses.

The energiser may be arranged to re-evaluate the threshold and if the fence line load has varied or varied significantly, set a new threshold value, or may be arranged simply to set a new threshold value without reference to the previous threshold value, each time the threshold value is reviewed. Preferably the energiser is arranged to set or reset the threshold value after each evaluation pulse or after groups of evaluation pulses based on a running average of the sensed characteristic associated with the evaluation pulses or groups of evaluation pulses.

The invention has application to electric fence energisers for electric fences in agricultural and pastoral as well as domestic applications, for containing animals such as stock within a defined area or to deter them from entering an area of crops or similar, and also in agricultural and industrial security fencing of installations such as for example power stations, prisons, and similar, and “electric fence energiser” should be understood as applying to all such applications. In addition “animal(s)” should be understood as including not only agricultural animals but also humans. The invention may have application in also protecting humans against danger from prolonged contact with an electric fence in an agricultural or pastoral application, as well as in security fencing applications for example where the primary objective is to deter persons.

### BRIEF DESCRIPTION OF DRAWINGS

Preferred forms of electric fence energisers and method of the invention are described with reference to the accompanying drawings by way of example only and without intending to be limiting, wherein:

FIG. 1 is a circuit diagram of one preferred form of energiser of the invention;

FIG. 2 is a circuit diagram of another preferred form of energiser of the invention;

FIGS. 3A, 3B, 3C and 3D are schematic pulse diagrams, showing in FIG. 3A low power evaluation pulses sent out by the energiser and a threshold voltage set by an energiser in accordance with the invention, in FIG. 3B low power evaluation pulses and a higher power deterrent pulse as the next pulse following a low power evaluation pulse falling below the threshold, in FIG. 3C low power evaluation pulses and a higher power deterrent pulse immediately on sensing of a low power evaluation pulse falling below the threshold, and in FIG. 3D low power evaluation pulses and a higher power deterrent pulse almost immediately on sensing a low power evaluation pulse falling below the threshold;

FIGS. 4A, 4B and 4C are further schematic pulse diagrams, showing in FIG. 4A low power evaluation pulses sent out by the energiser and a threshold voltage set by an energiser in accordance with the invention, in FIG. 4B low power evaluation pulses and a higher power deterrent pulse as the next pulse following a low power evaluation pulse falling below the threshold, and in FIG. 4C low power evaluation pulses and a higher power deterrent pulse immediately on sensing of a low power evaluation pulse falling below the threshold;

FIG. 5 is a flowchart showing the operation of a preferred form of energiser of the invention in accordance with the method of the invention (as may be implemented in a microprocessor controlling operation of the energiser); and

FIG. 6 is a flowchart showing the operation of another preferred form of energiser of the invention in accordance with the method of the invention (as may be implemented in a microprocessor controlling operation of the energiser).

### DESCRIPTION OF PREFERRED FORMS

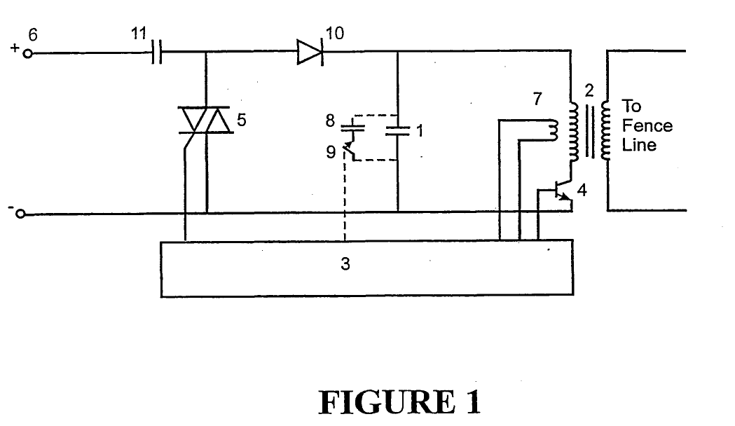

FIG. 1 is a circuit diagram of one preferred form of electric fence energiser of the invention. Storage capacitor or capacitor bank 1 is connected across the primary of output transformer 2, the secondary of which is in use connected to the fence line, typically via output terminals (not shown). A control circuit 3 comprising a programmed microprocessor or microcontroller is connected to IGBT 4, or another suitable switching device, which is operated by the microprocessor 3 to discharge the storage capacitor(s) 1 into the output transformer at each pulse. Operation of a switching device 5 such as a triac is also controlled by microprocessor 3 so that the microprocessor controls charging of the storage capacitor(s) 1 by charging circuit 6. In this preferred form triac 5, capacitor 11 and diode 10 form a controllable voltage doubler circuit. The storage capacitor(s) 1 is/are charged to a voltage as selected by the microprocessor 3 and discharged through transformer 2.

In the form shown a tertiary winding 7 forms part of transformer 2. This winding has a known turns ratio with respect to the secondary of the transformer so that the voltage across this tertiary winding can be correlated to the voltage on the secondary of the transformer (alternatively a tertiary winding may correlate current to current in the secondary of the output transformer, as indicative of load). When the microprocessor 3 activates IGBT 4 to discharge capacitor 1 and sends a pulse down the fence line the voltage (or current) on tertiary winding 7 is monitored by the microprocessor. The voltage on the fence line, and hence in the tertiary winding, decreases as the load on the fence line increases. The microprocessor 3 fires IGBT 4, evaluates information received from the tertiary winding 7, and can stop the discharge of capacitor 1 when the selected energy level on the fence line has been achieved.

The microprocessor may control the energy being delivered from the energiser output terminals by operating the triac 5 to increase or decrease the charging of the storage capacitor on each cycle. More preferably, where the storage capacitor is charged to a similar voltage on each cycle, the microprocessor controls the energy being delivered from the energiser output terminals by operating the IGBT 4 to increase or decrease the extent to which the storage capacitor is discharged to the fence on each cycle. The microprocessor may also switch in back-up capacitor or capacitor bank 8 by operating switch 9. The back-up capacitor or capacitor bank 8 may be switched into the circuit when higher power deterrent pulses are needed and switched out of the circuit when low power evaluation pulses are sent down the line.

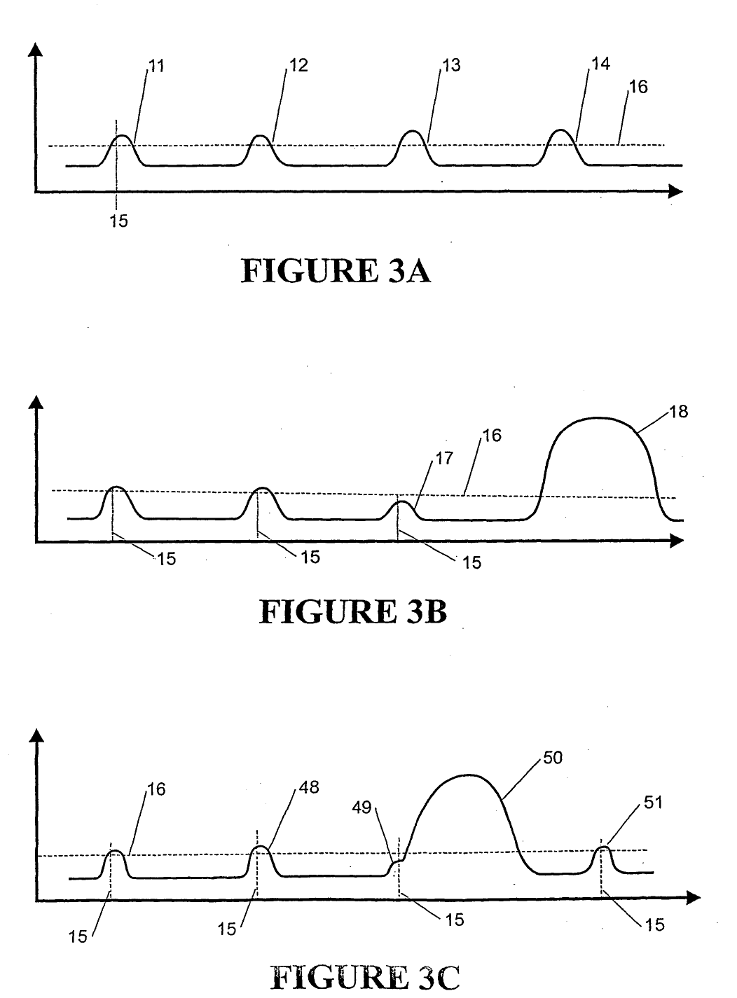

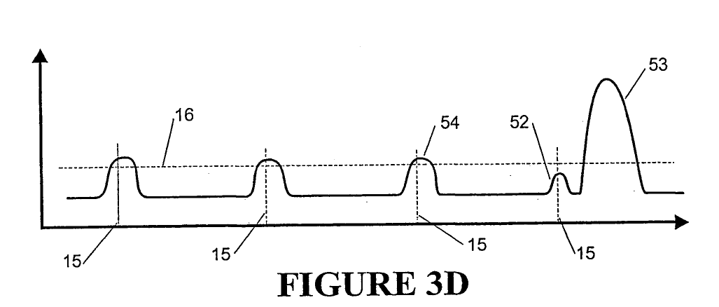

When the energiser is first turned on microprocessor 3 controls triac 5 and IGBT 4 to send at least one but preferably a predetermined number of low power evaluation pulses along the fence line, with the microprocessor sensing and storing the fence line voltage indication given by tertiary winding 7. Microprocessor 3 then in the preferred form calculates the average sensed voltage and sets a threshold voltage value, which is preferably below the average sensed voltage. The microprocessor controls IGBT 4 to continue to send out low power evaluation pulses. The fence line voltage is sensed by tertiary winding 7 and the microprocessor 3 continues to process the sensed fence line voltage as will be described in more detail with reference to FIGS. 3 to 6. When the microprocessor 3 determines that a higher power deterrent pulse is to be sent, the microprocessor may control triac 5 to charge storage capacitor 1 to a greater value, or the microprocessor 3 may control IGBT 4 to allow capacitor 1 to discharge for a longer period of time. Alternatively the microprocessor 3 may activate switch 9 to switch capacitor or capacitor bank 8 into the circuit.

After sending out a number of higher power deterrent pulses, when the microprocessor 3 determines that the next pulse will be a low power evaluation pulse the microprocessor 3 either controls triac 5 to charge storage capacitor to a low value, or controls IGBT 4 to allow capacitor 1 to discharge for a shorter period of time. Alternatively the microprocessor 3 may activate switch 9 to switch capacitor or capacitor bank 8 out of the circuit.

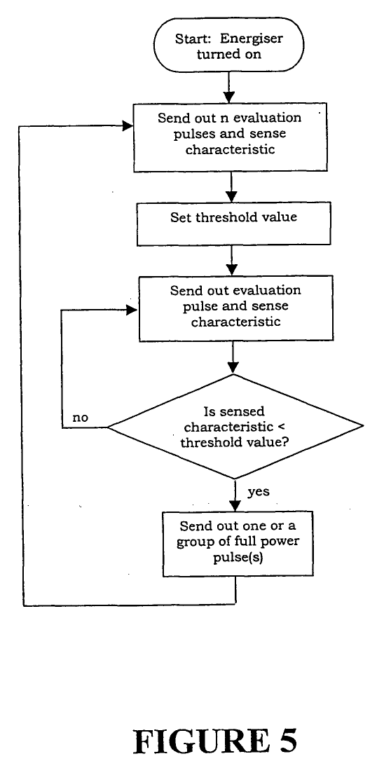

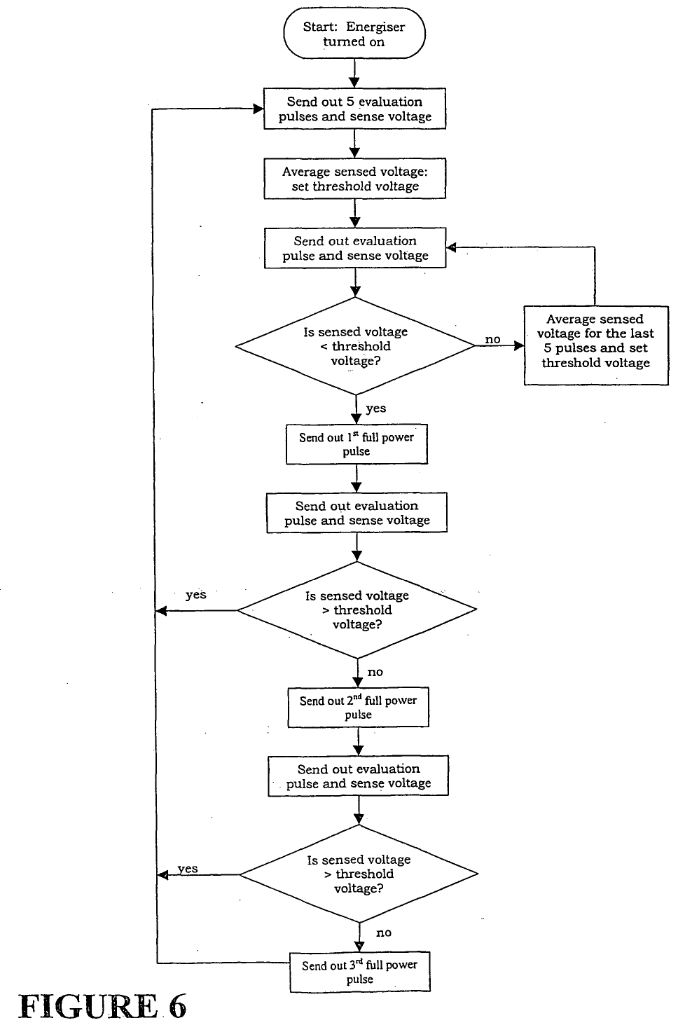

The microprocessor may operate the energiser in accordance with either of the flow charts of FIGS. 5 and 6 for example.

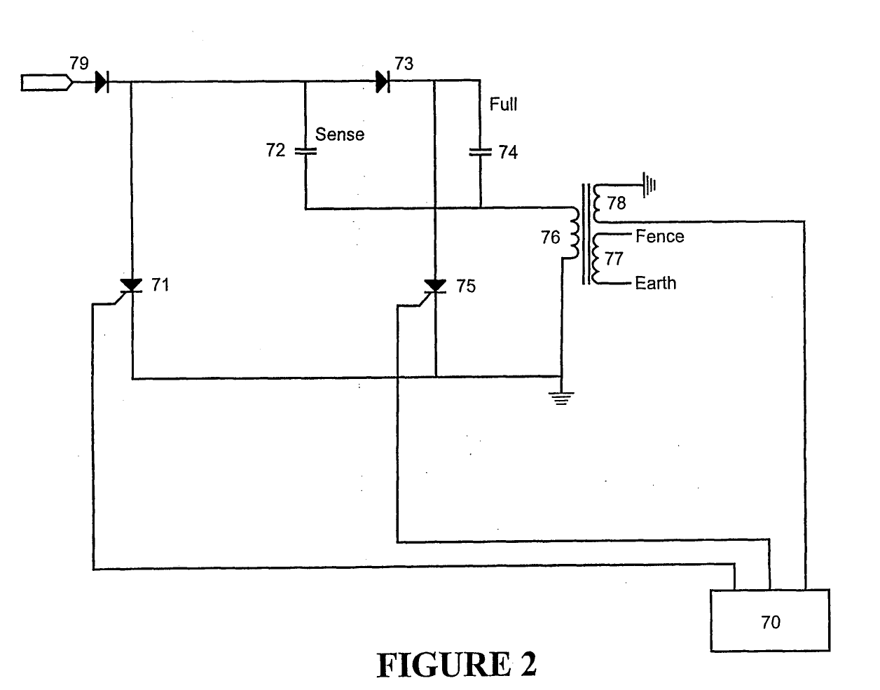

FIG. 2 is a circuit diagram of another preferred form of energiser of the invention. This energiser includes two storage capacitors 72 and 74 both of which are charged each time power is supplied to the energiser. SCRs 71 and 75 are controlled by a microprocessor or microcontroller 70 to allow capacitors 72 and 74 a discharge path through the primary 76 of the output transformer. The secondary 77 of the output transformer is connected to the fence line (not shown). A conventional or solar powered battery may be attached to pad 79 to power the energiser. Alternatively with suitable rectification an ac or switch mode power supply may be used.

Tertiary winding 78 forms part of the output transformer. This winding has a known turns ratio with respect to the secondary of the transformer so that voltage across this tertiary winding can be correlated to the voltage on the secondary of the transformer. When the microprocessor 70 activates either SCR 71 and/or SCR 75 to discharge capacitors 72 and/or 74 and send a pulse along the fence line the voltage on tertiary winding 78 is monitored. The voltage on the fence line, and hence in the tertiary winding, decreases as the load on the fence line increases. The microprocessor 70 fires SCR 71, evaluates information received form the tertiary winding 78 and can fire SCR 75 to discharge capacitor 74 if a higher power deterrent pulse is required.

In normal operation microprocessor 70 operates SCR 71 to discharge capacitor 72 along the fence line. Capacitor 72 is a small capacitor and the pulse sent along the fence line following the discharge of capacitor 72 is a low power evaluation pulse. Diode 73 ensures that capacitor 74 is charged when power is supplied to the energiser but does not discharge if SCR 71 is operated and capacitor 72 discharges. Capacitor 74 will only discharge when SCR 75 is operated. If SCR 75 is operated and SCR 71 is not then both capacitor 74 and capacitor 72 will discharge.

The microprocessor may operate the energiser and in particular SCRs 71 and 75 in accordance with either of the flow charts of FIGS. 5 and 6 for example.

Although in FIGS. 1 and 2 a tertiary winding on the output transformer is used to sense or assess the voltage (or current) of the output pulses, other means for sensing fence line load from the low power evaluation pulses (or in some instances higher power deterrent pulses) may be used such as sensing pulse width, the rate of discharge of the storage capacitor or capacitors of the energiser during the low power evaluation pulse(s) (or higher power pulses), or the degree of overshoot of the voltage or current wave form of the storage capacitor or capacitors during the lower power evaluation pulse(s) (or higher power pulses) for example.

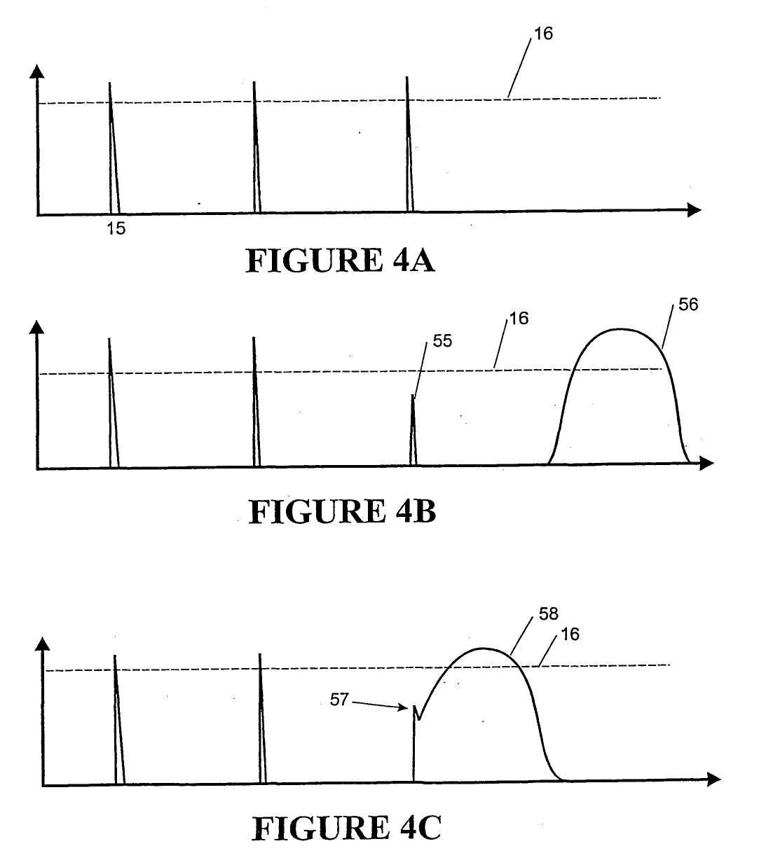

Operation of energisers of the invention is further illustrated by the pulse diagrams of FIGS. 3 and 4. FIG. 3A shows a series of low power evaluation pulses which are sent along the fence line. The pulses are sent at a regular pulse interval of typically about one second. Line 15 bisecting pulse 11 is approximately 40% of the way through pulse 11. This is the preferred sampling point for the energiser microprocessor to sample the voltage or current on a tertiary winding of the energiser for example. The low power evaluation pulses may preferably be sampled at between about 30 and 70% through the pulse period or alternatively at any other point. In a preferred form, once a first group of low power evaluation pulses has been sent along the fence line and the sensed voltage has been averaged the microprocessor sets a threshold voltage level, shown here as dash-dotted line 16. As can be seen in this figure sampling line 15 and threshold line 16 intersect inside pulse 11. This means that pulse 11 will be above the threshold voltage when sampled, which will not trigger a higher power deterrent pulse. In normal operation when no animals come into contact with the fence line the threshold voltage may vary but will do so only slowly with small variations in conditions on the fence line.

FIG. 3B illustrates operation of an energiser in a mode described in more detail with FIG. 7. In this mode the energiser re-evaluates the threshold voltage after every low power evaluation pulse and begins to send out higher power deterrent pulses when the sensed voltage of any low power evaluation pulse falls below the threshold voltage. Dash-dotted line 16 again shows the threshold voltage and dashed lines 15 show the preferred sampling point in each pulse. In this form after each pulse the microprocessor averages the sensed voltage of the previous five pulses. As shown the sensed voltage for pulse 17 falls below the threshold voltage indicating that an animal is in contact with the fence line. The energiser is then triggered to send higher power deterrent pulse 18. The microprocessor may have a second stored threshold voltage value for higher power deterrent pulses. If the higher power deterrent pulse is below the second stored voltage then the energiser sends a second higher power deterrent pulse along the fence line. This is described in more detail with reference to FIG. 6.

FIG. 3C illustrates operation of an energiser in an alternative mode in which a running average is used to set the threshold voltage. During each pulse the sensed voltage is compared to the threshold voltage. If the sensed voltage is less than the threshold voltage the energiser sends out a higher power deterrent pulse immediately. Dash-dotted line 16 shows the threshold voltage and dashed lines 15 show the sampling point for each low power evaluation pulse. Pulse 48 is above the threshold voltage so no higher power deterrent pulse is sent. However when pulse 49 is sampled it is below the threshold voltage indicating that an animal is in contact with the fence line. The energiser immediately sends out higher power deterrent pulse 50 which begins before the end of low power evaluation pulse 49. Following higher power deterrent pulse 50 the energiser sends out low power evaluation pulse 51. As shown in FIG. 3C low power evaluation pulse 51 is above the threshold voltage when sampled indicating that the animal is no longer in contact with the fence line.

FIG. 3D illustrates operation of an energiser in an alternative mode in which a running average is used to set the threshold voltage. The operation of the energiser in this alternative mode is similar to the operation of the energiser described with reference to FIG. 3C. The pulses before and including pulse 54 are above the threshold value shown by dash dotted line 16. When pulse 52 is sampled it falls below the threshold voltage indicating that an animal is in contact with the fence line. After a short delay the energiser sends out higher power deterrent pulse 53. The delay between sending low power evaluation pulse 52 and higher power pulse 53 is short and preferably so short that an animal in contact with the fence line feels only one pulse and does not detect that there are two pulses.

FIG. 4A shows a series of low power evaluation pulses sent along a fence line. The pulses are sent at a regular pulse interval, typically of about one second. Like the pulses described with reference to FIGS. 3A to 3D a characteristic of the pulses is sampled part way through the pulse and preferably between 30 and 70% through the pulse period or alternatively at any other point. Again a threshold value for the pulses is set, shown here by line 16. These evaluation pulses are higher voltage but are of short duration and have low power.

FIG. 4B illustrates operation of an energiser in a mode described in more detail with reference to FIG. 6. In this mode the energiser re-evaluates the threshold value after each low power evaluation pulse and begins to send out higher power deterrent pulses when the sensed voltage of any low power evaluation pulse falls below the threshold value. Dashed line 16 again shows the threshold value. As shown pulse 55 falls below the threshold value indicating that an animal is in contact with the fence. The energiser is then triggered to send out higher power deterrent pulse 56. In this case as all pulses are higher power pulses the energiser does not need to store a higher power threshold value and may use the threshold value shown by dashed line 16 to determine whether an animal remains in contact with the fence line during the full power pulses. If the voltage sensed in the higher power deterrent pulse is below the threshold value then the energiser continues to send out higher power deterrent pulses until either the voltage rises above the threshold value of a predetermined maximum number of higher power deterrent pulses are sent.

FIG. 4C illustrates operation of an energiser in an alternative mode in which a higher power deterrent pulse is sent immediately a low power evaluation pulse falls below the threshold level. Dashed line 16 shows the threshold value. Pulse 57 falls below the threshold value so pulse 58 is immediately sent out. Again the energiser may sense the voltage in the higher power deterrent pulses and compare this to the threshold value to determine whether an animal is still in contact with the fence line.

FIG. 5 is a flow chart showing the operation of an energiser of the invention, as may be implemented in a microprocessor or microcontroller or the like as part of the energiser. When the energiser is first turned on it sends at least one but preferably a group of low power evaluation pulses along the fence line. Preferably the low power evaluation pulses contain less than 50% and typically less than 10% of the power of the higher power deterrent pulses, and are sent down the line at the same frequency as higher power deterrent pulses. For example the first group of low power evaluation pulses may comprise five pulses. The energiser senses a characteristic associated with the evaluation pulses which varies with load, such as for example pulse voltage, pulse current, or pulse width of the lower power evaluation pulses, the rate of discharge of the storage capacitor or capacitors during the evaluation pulses, or the degree of overshoot of the voltage or current wave form of the storage capacitor or capacitors during the evaluation pulses, or any other characteristic associated with the low power evaluation pulses which varies with load on the fence line. The energiser sets a threshold value and continues to send low power evaluation pulses, sense a characteristic of the evaluation pulses (which is preferably the same but may be a different characteristic used to set the initial threshold), and compares this to the threshold value. If the value of the sensed characteristic changes relative to the threshold indicating that an animal has come into contact with the fence line, the energiser then sends out either a single higher power deterrent pulse, or a group of two or more higher power deterrent pulses, but not more than a predetermined maximum number of higher power pulses, such as three high power pulses for example. After sending the higher power pulse or pulses the energiser continues to send further low power evaluation pulses along the fence line, sense the low power evaluation pulses, and re-evaluate the original threshold and optionally set a new threshold value. If the animal has broken contact with the fence line the new threshold value may be the same as or not substantially different from the original threshold value before sending the higher power deterrent pulses. However in the event that an animal has become tangled in the fence line the threshold value will be reset at a new value taking into account the additional load that the tangled animal represents, and the energiser will continue to send low power evaluation pulses and will only again send higher power deterrent pulses if the sensed characteristic varies from the updated (current) threshold value indicating that a second animal has contacted the fence line. Thus the tangled animal is not exposed to the higher power pulses continually but only the low power evaluation pulses, and is exposed to higher power deterrent pulses only if a second animal contacts the fence line and for the duration that the second animal is in contact with the fence line (unless the second animal also becomes tangled in the fence line in which event after a predetermined number of higher power deterrent pulses the threshold will again be updated).

FIG. 6 is a flow chart showing the operation of a more sophisticated form of energiser of the invention. When the energiser is first turned on it sends a number of low power evaluation pulses along the fence line, for example five evaluation pulses. By way of example, in the flow chart the characteristic of the evaluation pulses which is sensed is pulse voltage, and the energiser senses the voltage on the fence line as each low power evaluation pulse is sent and averages the sensed voltage after the first group of pulses has been sent. A threshold voltage is then set at a level below the average voltage of the low power evaluation pulses.

Another low power evaluation pulse is sent by the energiser and the voltage on the fence line is sensed for the pulse, and compared to the threshold voltage. If the sensed voltage is greater than the threshold voltage then the sensed voltages of the previous five pulses are averaged and a new threshold voltage is calculated from this average. The energiser then sends a low power evaluation pulse and compares the sensed voltage of this pulse to the threshold voltage. If the sensed voltage is greater than the threshold voltage then again an average sensed voltage is calculated from the sensed voltage of the previous five pulses and a new threshold voltage is set calculated from the average sensed voltage. This running average process of sending out a pulse, comparing the sensed voltage of the pulse to the threshold voltage and if the sensed voltage is greater than the threshold voltage resetting the threshold voltage is the normal operation of the energiser and continues until the sensed pulse voltage falls below the threshold voltage.

When the sensed voltage falls below the threshold voltage typically because an animal has come into contact with the fence line, the energiser then sends out a higher power deterrent pulse, followed by a low power evaluation pulse. If the voltage sensed by the energiser for the low power evaluation pulse indicates that the animal is still in contact with the fence line the energiser sends out another higher power deterrent pulse. The higher power deterrent pulse is again followed by a low power evaluation pulse. The energiser continues to send out higher power deterrent pulses, followed by low power evaluation pulses until either the sensed voltage of the low power evaluation pulse(s) rises when the animal breaks contact with the fence line, or alternatively a predetermined number of higher power deterrent pulses have been sent consecutively along the fence line. If the sensed voltage rises to above the threshold voltage and either of the “yes” arrows are followed, dependent on how long the animal has been in contact with the fence line. Once one of these two conditions has been reached the energiser returns to send out a group of low power evaluation pulses and resets the threshold voltage. The energiser then continues to send out a low power evaluation pulse, compare the sensed voltage to the threshold voltage, calculate the average fence line voltage for the previous five pulses, and resets the threshold voltage.

An alternative is for the threshold voltage to remain where it was set before the sensed voltage fell below the threshold voltage and use this for the next comparison. When the algorithm returns to the top at least six low power evaluation pulses are sent out before a higher power deterrent pulse can be sent out. The algorithm may instead return to the step of sending out an evaluation pulse and sensing the voltage. If the algorithm returns to this stage then only one low power evaluation pulse is sent out before the first higher power deterrent pulse can be sent out. Another alternative is the return to the step of sending out a single evaluation pulse and sensing the voltage following detecting that an animal is no longer in contact with the fence line in the cases where the maximum number of higher power deterrent pulses have not been sent. In this alternative if an animal is caught in the fence line the load on the line caused by the animal will be taken into account when setting the threshold voltage.

It should be noted that when the sensed voltage of the low power evaluation pulse falls below the threshold voltage the energiser may begin a higher power deterrent pulse before the end of the low power evaluation pulse as shown by pulses 49 and 50 of FIG. 3C. This provides an automatic shock for any animal in contact with the fence line.

A further alternative to resetting the threshold voltage after every low power evaluation pulse with a sensed voltage greater than the threshold voltage is to average the sensed voltages only after every predetermined number of pulses. For example, average the sensed voltage and recalculate the threshold voltage after every five low power evaluation pulses with a sensed voltage greater than the threshold voltage.

Another alternative is to set a second threshold voltage for the higher power deterrent pulses. Such a threshold voltage may be set when the energiser is switched on using a higher power deterrent pulse or group of higher power deterrent pulses in a manner similar to setting up the threshold voltage for the low power evaluation pulses. Once the second threshold voltage has been fixed it may be reset at intervals. When an animal comes into contact with the fence line and the energiser begins to send higher power deterrent pulses along the fence line the voltage of these pulses can be sensed and compared to the higher power deterrent pulse threshold voltage. When the voltage sensed in the higher power deterrent pulses rises above the higher power deterrent pulse threshold voltage indicative of the animal breaking contact with the fence line the energiser may resume sending low power evaluation pulses. The setting of a threshold voltage for higher power deterrent pulses eliminates the need for sending low power evaluation pulses along the fence line after each higher power deterrent pulse.

A further alternative is that on switching on the energiser may immediately begin to send higher power deterrent pulses and may use a threshold set for the higher power deterrent pulses to determine when an animal contacts the fence line, and then whether the animal breaks contact with the fence line after one or two pulses or instead becomes tangled in the fence line. The voltage of the higher power deterrent pulses will be above the threshold when an animal is not in contact with the fence line, but will fall below the threshold when an animal contacts the fence line. If the energiser senses that not one or two but a greater number such as five or more (but up to a predetermined maximum) higher power deterrent pulses have a voltage below the threshold the energiser may be programmed to assume that an animal has become tangled in the fence line, and may then cease sending higher power deterrent pulses, send one or more low power evaluation pulse(s), set a threshold for the low power evaluation pulses based on the load seen by the energiser (including an animal assumed to be tangled in the fence line), and continue to send low power evaluation pulses and only send further higher power deterrent pulses if the threshold set for the low power evaluation pulses is breached indicating that a second animal has contacted the fence line. In that event one or a limited number of higher power deterrent pulses would again be sent to deter the second animal to break contact with the fence line, following which the energiser would return to sending low power evaluation pulses until the fence line is again contacted.

In general when a first animal contacts the electric fence line the sensed voltage of the next low power evaluation pulse will drop, and when compared to the threshold voltage will be less than the previously set threshold and the energiser will commence sending higher power deterrent pulses along the fence line. After each higher power deterrent pulse the load on the fence line is sensed, preferably by sensing the voltage in a low power evaluation pulse, to determine whether the animal is still in contact with the fence line.

Most animals will break contact with an electric fence line upon receiving a single higher power deterrent pulse. If an animal has not broken contact with the fence line after a predetermined number of higher power deterrent pulses the energiser returns to sending out low power evaluation pulses. This is typically because the animal is caught in the fence line and is unable to free itself. An animal caught in an electric fence line may eventually die of exhaustion if it receives higher power deterrent electric shocks from the energiser continuously. An animal receiving low power electric shocks will survive for a much longer period of time allowing a farmer more time to find and rescue the trapped animal. For this reason if an animal is still in contact with the electric fence line after receiving a limited number of higher power deterrent pulses the energiser switches back to sending low power evaluation pulses, on the assumption that the animal is trapped, and sets a new threshold voltage which takes into account the additional load of the trapped animal.

If a second animal comes into contact with the electric fence line while the first animal is trapped, the sensed voltage will again drop below the threshold voltage. In this case the energiser will begin sending out higher power deterrent pulses until either the one of the animals break contact with the fence line or a predetermined number of higher power deterrent pulses have been sent. The first animal will be shocked by the higher power deterrent pulses but once the second animal breaks contact with the fence line or a predetermined number of higher power deterrent pulses have been sent the low power evaluation pulses will begin again. In this way the energiser still provides full shocking power to animals coming into contact with the fence line even when an animal is caught in the fence line, while delivering the minimum possible number of higher power deterrent pulses which prolongs the life of the trapped animal.

The maximum number of higher power deterrent pulses sent down the electric fence line at any one time is limited. Generally an animal in contact with an electric fence line will break contact with the fence line upon receiving a single higher power deterrent pulse. Occasionally an animal will remain in contact with an electric fence line after a higher power deterrent pulse but this is rare. Only a trapped animal will remain in contact with an electric fence line after receiving for example three higher power deterrent pulses (which it is thought provides the ideal deterrent and any more will begin to unnecessarily use energy).

It will be appreciated that low power and higher power deterrent pulses may be sent individually or in groups of any maximum number of pulses. For example the energiser may send out a maximum of four higher power deterrent pulses and may average pulses in groups of three. An energiser of the invention will typically send out more low power evaluation pulses than high power deterrent pulses, thus reducing power consumption for a mains powered energiser, or increasing battery life for a battery powered energiser. It may be possible that fewer solar panels are required for a solar powered energiser.

In the preferred forms of energiser described above one or more low power evaluation pulses are sent down the fence line on switch-on of the energiser to set the initial threshold associated with the low power evaluation pulses. It is alternatively possible that an energiser may have an initial threshold value pre-programmed into it appropriate for a fence line of a common type and common length, or that the energiser may provide a number of user selectable threshold options, for a range of standard fence line types of standard lengths for example. Alternatively or additionally an energiser of the invention may include a sensitivity control for adjusting the threshold value or for manually setting the initial threshold. A further but less preferred option is that load on the fence line is sensed via an initial series of higher power deterrent pulses rather than low power evaluation pulses, and the load value used to set a threshold for low power evaluation pulses which are sent subsequently.

Energisers of the invention may include a communications module whereby a signal is sent to a farmer or security centre in the event that the energiser determines that an animal (including person) has become tangled in the fence line. For example the energiser may include a cellphone or pager board and be arranged to send a text message or paging message to a farmer, or may use any other communications medium.

Weather conditions and grass touching an electric fence line are two other factors that may change the load sensed on the fence line. If the weather conditions change or grass growing beside the fence line begins to touch the fence line the characteristic associated with the evaluation pulses that varies with load on the fence line, which is sensed by the energiser will change. If the sensed characteristic falls below the threshold then higher power deterrent pulse(s) will be sent down the fence line before low power evaluation pulses recommence as is the case for an animal trapped in the fence line. If the sensed characteristic does not fall below the threshold then the threshold value is re-evaluated. The energiser thus provides an energy efficient system that takes account of weather changes and other factors and send out up to a predetermined number of higher power deterrent pulses only when the sensed voltage falls below the threshold voltage. Any change in weather conditions or grass growing against the fence line for example, will at most result in a predetermined maximum number of higher power pulses before a new threshold is set and low power evaluation pulses continue.

The foregoing describes the invention including preferred forms thereof. Alterations and modifications as will be obvious to those skilled in the art are intended to be incorporated within the scope hereof as defined in the accompanying claims.

1. A method of operating an electric fence energiser including causing the energiser to:
send one or more low power evaluation pulse(s) along a fence line, sense a characteristic associated with said evaluation pulse(s) that varies with load on the fence line, and set a threshold value based on said sensed characteristic,
send one or more further low power evaluation pulses along the fence line, sense a characteristic associated with the evaluation pulse(s) that varies with load on the fence line, compare the sensed characteristic to the threshold value, and when a change in the sensed characteristic relative to the threshold value indicative of an animal in contact with the fence line is detected, send one or more but not more than a predetermined maximum number of higher power deterrent pulses along the fence line,
subsequently send one or more further low power evaluation pulses along the fence line, sense a characteristic associated with the evaluation pulses that varies with load on the fence line, and either re-evaluate and optionally reset the threshold, or set a new threshold value, and
continue to send further low power evaluation pulses along the fence line and sense a characteristic associated with the low power evaluation pulse(s) that varies with load on the fence line, and compare the sensed characteristic to the current threshold value, and send one or more further but not more than a predetermined maximum number of higher power deterrent pulses along the fence line if a change relative to the threshold value is again detected.

2. A method according to claim 1 including sensing a characteristic associated with the low power evaluation pulse(s) that varies with load on the fence line, by sensing one or more of the pulse voltage, pulse current, or pulse width of the low power evaluation pulse(s), the rate of discharge of a storage capacitor or capacitors of the energiser during the low power evaluation pulse(s), or the degree of overshoot of the voltage or current wave form of a storage capacitor or capacitors of the energiser during the low power evaluation pulse(s).

3. A method of operating an electric fence energiser comprising causing the energiser to:
send one or more low power evaluation pulse(s) along a fence line, sense a characteristic which is the voltage of said evaluation pulse(s) and set a threshold value based on said sensed voltage,
send one or more further low power evaluation pulses along the fence line, sense a characteristic which is the voltage of the evaluation pulse(s), compare the sensed voltage to the threshold value, and when a change in the sensed voltage relative to the threshold value indicative of an animal in contact with the fence line is detected, send one or more but not more than a predetermined maximum number of higher power deterrent pulses along the fence line,
subsequently send one or more further low power evaluation pulses along the fence line, sense a characteristic which is the voltage of the evaluation pulses, and either reevaluate and optionally reset the threshold, or set a new threshold value, and
continue to send further low power evaluation pulses along the fence line and sense the voltage of the low power evaluation pulse(s) and compare the sensed voltage to the current threshold value, and send one or more further but not more than a predetermined maximum number of higher power deterrent pulses along the fence line if a change in the sensed voltage relative to the threshold value is again detected.

4. A method according to any one of claims 1 to 3 including causing the energiser to send said higher power deterrent pulses as a group of two or more pulses when a change in the sensed characteristic of at least one low power evaluation pulse that varies with load on the fence line, below said threshold is detected indicative of an animal in contact with the fence line.

5. A method according to claim 4 including causing the energiser to sense a characteristic associated with the higher power deterrent pulses that varies with load on the fence line, and to terminate sending of the remainder of the group of higher power deterrent pulses if the sensed characteristic associated with the higher power deterrent pulses changes indicative of an animal breaking contact with the fence line.

6. A method according to claim 4 including causing the energiser to send a low power evaluation pulse after each higher power deterrent pulse or after a subgroup or subgroups of higher power deterrent pulses, and sense a characteristic associated with the low power evaluation pulse that varies with load on the fence line, and terminate sending of the remainder of the group of higher power deterrent pulses if the sensed characteristic changes indicative of an animal breaking contact with the fence line.

7. A method according to any one of claims 1 to 6 wherein the low power evaluation pulses contain less than about 50% of the power of the higher power deterrent pulses.

8. A method according to any one of claims 1 to 6 wherein the low power evaluation pulses contain less than 10% of the power of the higher power deterrent pulses.

9. A method according to any one of claims 1 to 8 wherein the threshold value(s) are set at a level below the level of the sensed characteristic of the evaluation pulse or pulses.

10. A method according to any one of claims 1 to 9 including causing the energiser to reset the threshold value after each low power evaluation pulse or after groups of low power evaluation pulses based on a running average of the sensed characteristic associated with the evaluation pulses or groups of evaluation pulses.

11. A method according to any one of claims 1 to 10 including causing the energiser to send the low power evaluation pulses as substantially full voltage pulses relative to the voltage of the higher power deterrent pulses, but of shorter duration.

12. A method according to any one of claims 1 to 11 including causing the energiser to sense the low power evaluation pulses at between 30% and 70% of the duration of each evaluation pulse.

13. A method according to any one of claims 1 to 12 including causing the energiser to sense a characteristic associated with the low power evaluation pulses that varies with load on the fence line, by sampling the voltage on or current in a tertiary winding of an output transformer of the energiser.

14. A method according to any one of claims 1 to 13 including causing the energiser to send a higher power deterrent pulse or the first higher power deterrent pulse, after substantially the same pulse interval between preceding pulses when the sensed characteristic associated with a low power evaluation pulse that varies with load on the fence line, changes relative to the threshold value.

15. A method according to any one of claims 1 to 13 including causing the energiser to send a higher power deterrent pulse or the first higher power deterrent pulse, in a time shorter than the pulse interval between preceding pulses when the sensed characteristic associated with an evaluation pulse changes relative to the threshold value.

16. An electric fence energiser arranged to:
send one or more low power evaluation pulse(s) along a fence line, sense a characteristic associated with said evaluation pulse(s) that varies with load on the fence line, and set a threshold value based on said sensed characteristic,
send one or more further low power evaluation pulses along the fence line, sense a characteristic associated with the evaluation pulse(s) that varies with load on the fence line, compare the sensed characteristic to the threshold value, and when a change in the sensed characteristic relative to the threshold value indicative of an animal in contact with the fence line is detected, send one or more but not more than a predetermined maximum number of higher power deterrent pulses along the fence line,
subsequently send one or more further low power evaluation pulses along the fence line, sense a characteristic associated with the evaluation pulses that varies with load on the fence line, and either re-evaluate and optionally reset the threshold, or set a new threshold value, and
continue to send further low power evaluation pulses along the fence line and sense a characteristic associated with the low power evaluation pulse(s) that varies with load on the fence line, and compare the sensed characteristic to the current threshold value, and send one or more further but not more than a predetermined maximum number of higher power deterrent pulses along the fence line if a change relative to the threshold value is again detected.

17. An electric fence energiser according to claim 16 arranged to sense a characteristic associated with the low power evaluation pulse(s) that varies with load on the fence line, by sensing one or more of the pulse voltage, pulse current, or pulse width of the low power evaluation pulse(s), the rate of discharge of a storage capacitor or capacitors of the energiser during the low power evaluation pulse(s), or the degree of overshoot of the voltage or current wave form of a storage capacitor or capacitors of the energiser during the low power evaluation pulse(s).

18. An electric fence energiser arranged to:
send one or more low power evaluation pulse(s) along a fence line, sense a characteristic which is the voltage of said evaluation pulse(s) and set a threshold value based on said sensed voltage,
send one or more further low power evaluation pulses along the fence line, sense a characteristic which is the voltage of the evaluation pulse(s), compare the sensed voltage to the threshold value, and when a change in the sensed voltage relative to the threshold value indicative of an animal in contact with the fence line is detected, send one or more but not more than a predetermined maximum number of higher power deterrent pulses along the fence line,
subsequently send one or more further low power evaluation pulses along the fence line, sense a characteristic which is the voltage of the evaluation pulses, and either re-evaluate and optionally reset the threshold, or set a new threshold value, and
continue to send further low power evaluation pulses along the fence line and sense the voltage of the low power evaluation pulse(s) and compare the sensed voltage to the current threshold value, and send one or more further but not more than a predetermined maximum number of higher power deterrent pulses along the fence line if a change in the sensed voltage relative to the threshold value is again detected.

19. An electric fence energiser according to any one of claims 16 to 18 arranged to send said higher power deterrent pulses as a group of two or more pulses when a change in the sensed characteristic of at least one low power evaluation pulse that varies with load on the fence line, below said threshold is detected indicative of an animal in contact with the fence line.

20. An electric fence energiser according to claim 19 arranged to sense a characteristic associated with the higher power deterrent pulses that varies with load on the fence line, and to terminate sending of the remainder of the group of higher power deterrent pulses if the sensed characteristic associated with the higher power deterrent pulses changes indicative of an animal breaking contact with the fence line.

21. An electric fence energiser according to claim 19 arranged to send a low power evaluation pulse after each higher power deterrent pulse or after a subgroup or subgroups of higher power deterrent pulses, and sense a characteristic associated with the low power evaluation pulse that varies with load on the fence line, and terminate sending of the remainder of the group of higher power deterrent pulses if the sensed characteristic changes indicative of an animal breaking contact with the fence line.

22. An electric fence energiser according to any one of claims 16 to 21 wherein the low power evaluation pulses contain less than about 50% of the power of the higher power deterrent pulses.

23. An electric fence energiser according to any one of claims 16 to 21 wherein the low power evaluation pulses contain less than 10% of the power of the higher power deterrent pulses.

24. An electric fence energiser according to any one of claims 16 to 23 wherein the threshold value(s) are set at a level below the level of the sensed characteristic of the low power evaluation pulse or pulses.

25. An electric fence energiser according to any one of claims 16 to 24 arranged to reset the threshold value after each low power evaluation pulse or after groups of low power evaluation pulses based on a running average of the sensed characteristic associated with the evaluation pulses or groups of evaluation pulses.

26. An electric fence energiser according to any one of claims 16 to 25 arranged to send the low power evaluation pulses as substantially full voltage pulses relative to the voltage of the higher power deterrent pulses, but of shorter duration.

27. An electric fence energiser according to any one of claims 16 to 26 arranged to sense the low power evaluation pulses at between 30% and 70% of the duration of each evaluation pulse.

28. An electric fence energiser according to any one of claims 16 to 27 arranged to sense a characteristic associated with the low power evaluation pulses by sampling the voltage on or current in a tertiary winding of an output transformer of the energiser.

29. An electric fence energiser according to any one of claims 16 to 28 arranged to send a higher power deterrent pulse or the first higher power deterrent pulse, after substantially the same pulse interval between preceding pulses when the sensed characteristic associated with a low power evaluation pulse that varies with load on the fence line, changes relative to the threshold value.

30. An electric fence energiser according to any one of claims 16 to 28 arranged to send a higher power deterrent pulse or the first higher power deterrent pulse, in a time shorter than the pulse interval between preceding pulses when the sensed characteristic associated with a low power evaluation pulse that varies with load on the fence line, changes relative to the threshold value.

31. A method of operating an electric fence energiser including causing the energiser to:
send one or more low power evaluation pulses along the fence line, sense a characteristic associated with the evaluation pulse(s) that varies with load on the fence line, compare the sensed characteristic to a threshold value, and when a change in the sensed characteristic relative to the threshold value indicative of an animal in contact with the fence line is detected, send one or more but not more than a predetermined maximum number of higher power deterrent pulses along the fence line,
subsequently send one or more further low power evaluation pulses along the fence line, sense a characteristic associated with the evaluation pulses that varies with load on the fence line, and either re-evaluate and optionally reset the threshold, or set a new threshold value, and
continue to send further low power evaluation pulses along the fence line and sense a characteristic associated with the low power evaluation pulse(s) that varies with load on the fence line, and compare the sensed characteristic to the current threshold value, and send one or more further but not more than a predetermined maximum number of higher power deterrent pulses along the fence line if a change relative to the threshold value is again detected.

32. An electric fence energiser arranged to:
send one or more low power evaluation pulses along the fence line, sense a characteristic associated with the evaluation pulse(s) that varies with load on the fence line, compare the sensed characteristic to a threshold value, and when a change in the sensed characteristic relative to the threshold value indicative of an animal in contact with the fence line is detected, send one or more but not more than a predetermined maximum number of higher power deterrent pulses along the fence line,
subsequently send one or more further low power evaluation pulses along the fence line, sense a characteristic associated with the evaluation pulses that varies with load on the fence line, and either re-evaluate and optionally reset the threshold, or set a new threshold value, and
continue to send further low power evaluation pulses along the fence line and sense a characteristic associated with the low power evaluation pulse(s) that varies with load on the fence line, and compare the sensed characteristic to the current threshold value, and send one or more further but not more than a predetermined maximum number of higher power deterrent pulses along the fence line if a change relative to the threshold value is again detected.
